(19) United States
(12) Patent Application Publication
(10) Pub. No.: US 2006/0272461 A1
(43) Pub. Date: Dec. 7, 2006

(54) Food presentation method

(76) Inventors: Andrea E. Atwater, Barrington, IL (US); Andrew J. Bartole, Arlington Heights, IL (US)

Correspondence Address: ANDREA E. ATWATER, 114 RIVERWALK LANE, BARRINGTON, IL, 60010, US

(21) Appl. No.: 11/502,776

(22) Filed: Aug. 11, 2006

Related U.S. Application Data
(62) Division of application No. 10/459,821, filed on Jun. 11, 2003.

(51) Int. Cl. B26B 3/00

(52) U.S. Cl. 83/13; 30/303

(57) ABSTRACT

A method-enabling foldable blade assembly sections and displays an entire food item within a baking pan into smaller sections. The cutter has an orthogonally arranged lattice of cutting blades sized and shaped to fit within a baking pan having an upright side for sectioning an entire food item within the food preparation container into a plurality of smaller sections. A plurality of hinge connections connects the cutting blades providing structure for pivotally changing the relationship between the cutting blades from the orthogonal arrangement to a substantially coplanar arrangement for storage. The end portions of the cutting blades may be angled to compensate for angularity of the upright side of the baking pan during use. A removable handle is used for providing manual force perpendicular to the cutting blades during use.

### PRIOR HISTORY

This application is a divisional application claiming priority to pending U.S. patent application Ser. No. 10/459,821, filed in the United States Patent and Trademark Office on Jun. 11, 2003.

### BACKGROUND OF THE INVENTION

1. Field of the Invention

The claimed invention generally relates to a method-enabling assembly for sectioning a food preparation. More specifically, the claimed invention relates to certain methodology enabled by a uniquely configured blade assembly whereby users thereof can section and display food preparations as form-prepared in food preparation containers and the like.

2. Description of the Prior Art

It is common practice to bake food items such as brownies, cakes, and cookies as one continuous sheet in food preparation containers of standard sizes such as 9 inches by 13 inches and 8 inches by 8 inches, or any number or circular food preparation containers having variously sized diameters. The baked or otherwise prepared food item is then commonly sliced into a plurality of smaller food items such as bars, squares, or wedge-shaped pieces for removal from the baking pan or food preparation container. The task of slicing the food preparation into bars, squares, or wedge-shaped pieces is commonly performed by using a knife or other similar instrument having a single cutting blade that is customarily used to make several individual longitudinal and lateral sectioning cuts defining the sides of each of the bars, squares, or wedge-shaped pieces.

The task of slicing the food preparation into a number of smaller food sections with a single bladed knife requires overcoming several challenges in order to achieve a desirable end result. One of the challenges that must be overcome is ensuring that the sectioning cuts are made straight. Freehandedly cutting a straight line in a sheet of brownies, for example, using a single bladed knife without reference to a straight edge such as the upright side of the food preparation container is often difficult to accomplish. Another challenge that must be overcome is ensuring that the sectioning cuts are made completely through the food item. If close attention is not paid to the depth of the cut made by the knife, the individual bars, squares, or wedge-shaped pieces will often not be completely separated. An even further challenge that must be overcome is ensuring that the food sections are sized appropriately. It is commonly desired to evenly section the food item so that all of the food sections are of the same size. However, it is difficult to achieve substantially equally sized and shaped food sections when freehandedly cutting the food preparation with a single blade knife.

There are several different types of cutting apparatuses in the prior art that use multiple cutting blades to cut food items into smaller sections. Some of these prior art devices are disclosed here in the form of previously issued United States patents. However, these previously issued United States patents do not disclose or teach a device that addresses the previously mentioned problems concerning cutting a sheet of brownies or similar type food item into a plurality of smaller portions within a baking pan having upright sides.

U.S. Pat. No. 1,175,512 ('512 patent), which issued to Flemal, discloses a Scraper. The '512 patent teaches a scraper comprising a plurality of assembling bars, a plurality of scraping blades arranged transversely of and interlocked with the assembling bars, a plate provided with depending flanges adapted to interlock with certain of the assembling bars, a hand grasp operatively connected to the plate, and clamping members coacting with the plate and certain of the assembling bars for maintaining the plate in applied position.

U.S. Pat. No. 1,754,541 ('541 patent), which issued to Benoit, discloses an Egg Case Filler. The '541 patent teaches a filler structure having cross walls. One of the cross walls is edge-notched to interlock with the other wall, which other wall comprises a D-slot through which the first wall is extended. The edges defining the D-slot present a bowed portion, the ends of which are shouldered and extended past a connecting straight portion to accommodate the notched wall when bowed without catching upon the notches in the edges thereof and to support the notched wall when straightened between the straight and shouldered portions which lie upon opposite sides of the wall.

U.S. Pat. No. 2,118,211 ('211 patent); which issued to Lutz, discloses a Liquid Congealing Apparatus. The '211 patent teaches a removable grid for dividing an ice tray into a plurality of cells for forming ice cubes comprising a single strip of flexible metal bent to form a plurality of vertical transverse walls of double thicknesses of metal, a plurality of vertical longitudinal walls formed of a single thickness of metal connecting adjacent thicknesses of the transverse walls, and a plurality of vertical longitudinal wall members extending between the transverse walls and each comprising two thicknesses of metal bent from the transverse walls and folded adjacent a contiguous transverse wall.

U.S. Pat. No. 4,000,845 ('845 patent), which issued to Zeller, discloses a Partition Assembly and Partition Strips Therefor. The '845 patent teaches a partition assembly having interlocking longitudinal and transverse partition strips to form compartments or cells for the reception of bottles, cans or other containers. The strips have sections that form the walls of the cells and are defined by spaced slots in each strip extending from one edge and a substantial depth into the strip and relatively shallow notches in the opposite edge of the strip in alignment with said slots. A set of sections, including the section at one end of each strip, has tabular projections near one edge extending into the slots in one direction, and a section at the opposite end of the strip has a tabular projection extending into a slot but in the opposite direction, the slots of the longitudinal strips interfitting with the slots of the transverse strips with the tabs of one interlocking in notches of the other forming a partition assembly.

U.S. Pat. No. 4,648,300 ('300 patent), which issued to Hassenfelt, discloses a Biscuit Cutting Apparatus. The '300 patent teaches a square frame surrounding and extending upwardly from a planar cutting surface to define a dough compartment. A plurality of vertical slots in each side wall extends from the top edge thereof down to the cutting surface to provide a guide for a cutting blade inserted therein. The slots are arranged in such a pattern that three, four, or six equal width slices may be formed in each direction depending on the slots selected for use. The cutter blade is accurately shaped along the bottom from end to end to ensure good contact with the cutting surface. An enlarged end portion at each end of the cutting blade prevents inadvertent dislodgement of the cutting blade during usage. A flour trough is provided on one side wall to facilitate the maintenance of a floured cutting blade during usage.

U.S. Pat. No. 5,074,777 ('777 patent), which issued to Garner, discloses an Apparatus for Making a Split Pie. The '777 patent teaches a pie dividing assembly adapted to be inserted into a conventional circular pie pan once it is covered with a bottom sheet or layer of pie dough for separating the pie into a plurality of separate and distinct pie sections, preferably two, each adapted to receive a different and distinct pie filling therein before an optional top layer or cover of pie dough is placed thereover and the pie baked. Normally, after the pie is at least partially baked, approximately ⅔ baked, to where the pie filling has set, the pie divider is removed and the pie allowed to bake until done at which time the fully baked single unitary pie will have a plurality of sections each having a different and distinct pie filling therein. In the preferred embodiment of the present invention, the pie divider separates the pie into two equally dimensioned halves but embodiments are provided for separating the pie into three, four, six, eight, etc. dimensionally equal or unequal sections, as desired. The invention also contemplates a split-filling pie made as a product by process, and a method of making a split-filling pie. Another embodiment is provided for dividing a pizza into a plurality of different and distinct slices before the topping or combination of toppings is added.

U.S. Pat. No. 5,343,623 ('623 patent), which issued to Cole, discloses a Knife Assembly for Cutting a Food Product. The '623 patent teaches a knife blade and knife blade assembly for cutting food products into sticks or slices without causing surface cracking. The knife blade has a cutting portion defining a cutting edge and is mounted in the knife assembly such that a tension force is exerted on the knife blade in the plane of the cutting edge. The cutting edge of the knife blade is not sharp, but is generally flat and extends between parallel sides of the knife blade. The individual knife blades are formed of stainless steel and are electro-polished to remove any surface defects or sharp edges which may produce stress concentrations. This enables a significant tension force to be applied to the knife blade without diminishing its useful life. The electro-polishing process may also round off the comers of the juncture between the flat cutting edge and the parallel knife blade sides.

U.S. Pat. No. 5,579,582 ('582 patent), which issued to Carlson, discloses a Puzzle Cookie Cutter. The '582 Paten teaches a puzzle cookie cutter comprising a cutting die holder and at least one cutting die removably securable in the holder. The die or dies provide for the cutting of cookie dough, batter, or the like into several separate, irregularly shaped and sized interfitting pieces, which pieces may be reassembled as a puzzle after baking to provide entertainment for the consumer of the cookie. The dies may be provided in virtually any regular or irregular geometric shape, animal or other caricature or representation, and/or any alphanumeric character, as desired. The die or dies may also provide for the spaced apart separation of the cut dough or batter, to allow for expansion or flow of the batter or dough during the baking process, in order that the baked pieces will have a close fit with one another without interference. The cut pieces may be baked adjacent one another on a sheet or pan and decorated after the baking process as desired, then separated randomly to provide a challenge akin to that of the assembly of a relatively simple jigsaw or picture puzzle, in addition to the enjoyment of eating the baked cookie pieces.

U.S. Pat. No. 5,597,113 ('113 patent), which issued to Bradford, discloses a Recyclable Container Partition. The '113 paten teaches a collapsible partition assembly comprising a set of parallel longitudinal dividers and a set of parallel transverse dividers intersecting at a plurality of intersections. Each of the longitudinal dividers has a series of evenly spaced slots which extend downwardly from a top edge of the longitudinal divider to approximately the middle of the longitudinal divider. Each transverse divider has a series of evenly spaced slots, each slot extending upwardly from a bottom edge of the transverse divider to approximately the middle of the transverse divider. The slots of the longitudinal and transverse dividers engage with one another at the intersections. Dividers are secured to each other at each intersection by a securement bead which extends from a point proximate the top edge of the intersection to proximate the bottom edge of the intersection. The intersecting dividers create four angles. The securement bead runs along one angle and permits the partition assembly to be collapsed and recycled.

U.S. Pat. No. 5,848,470 ('470 patent), which issued to Anderson, discloses an Impact Actuated Baker Grid Device. The '470 patent teaches an impact actuated bakery grid device for producing uniform portions of baked goods wherein the grid device includes a force generating unit operatively associated with a handle member which is connected at widely spaced locations on a grid member for forcibly ejecting the portions of baked goods from within the confines of a plurality of compartments within the grid member.

U.S. Pat. No. 6,276,918 ('918 patent), which issued to Slaughter et al., discloses a Dough Cutting Apparatus. The '918 patent teaches a dough cutting apparatus comprising a plurality of spaced apart blades the lower edges of which are uniformly curved from one end of said blades to the other and a plurality of intersecting spaced apart blades the lower edges of which are straight. The blades cooperate to form multiple uniformly sized cavities therebetween. A handle is attached to the blades for engagement by the user of the apparatus for rocking the apparatus along the lower edges of the curved blades to separate a layer of dough into separate multiple dough products.

These previously issued United States patents do not disclose or teach a food-presentation or sectioning method usable to section a food item or preparation within a food preparation container into a plurality of uniformly sized and shaped smaller portions. Therefore, there is a need for certain methodology for uniformly and simultaneously sectioning and presenting a food item or preparation within a container such as a food preparation container for displaying the food preparation in smaller portions. There is a further need for a method of this type. The methodology is enabled by a blade assembly, expandable for sectioning and displaying a food preparation in smaller food sections, and collapsible into a folded form for ease of storage.

### SUMMARY OF THE INVENTION

To provide an answer for these needs, as well as other that will become apparent after reading this specification and viewing the appended drawings, the claimed invention provides a method-enabling food bar cutter that enables certain food-sectioning and/or food-presenting methodology for sectioning and/or presenting a plurality of smaller food portions from a food item sheet within a baking pan having upright sides.

It is an object of the claimed invention to provide a method-enabling food bar cutter capable of making straight sectioning cuts. It is a further object of the claimed invention to provide a method-enabling food bar cutter capable of making sectioning cuts of uniform depth. It is an even further object of the claimed invention to provide a method-enabling food bar cutter capable of sectioning an entire food item within a baking pan into a plurality of uniformly shaped smaller sections. It is still a further object of the claimed invention to provide a method-enabling food bar cutter having a plurality of opposingly oriented blades that are collapsible into a compact configuration for storage. The method-enabling food bar cutter generally comprises an orthogonally arranged lattice of cutting blades, a plurality of hinge connections, and a pair of handles.

The orthogonally arranged lattice of cutting blades are sized and shaped to fit within a food preparation container, such as a 9 inch by 12 inch baking pan having upright sides. The cutting blades are made to section an entire food item within the baking pan into a plurality of smaller sections or bars. The cutting blades have end portion angled to compensate for angularity of the upright outer side walls of the baking pan. The food bar cutter may also have edge blades connected to the ends of the lateral cutting blades and lorigitudinal cutting blades for cutting off the edge of the brownie sheet about the margin of the food item.

The plurality of hinge connections hingedly connects the cutting blades at their intersections to provide means for pivotally changing the relationship between the cutting blades from the orthogonal arrangement to a substantially coplanar arrangement. The folded coplanar arrangement of the brownie bar cutter allows for easy storage while not in use.

The pair of handles allows a user to provide manual force perpendicular to the cutting edge of the cutting blades during use. The handles may be removable or permanently fixed to the cutting blades.

### BRIEF DESCRIPTION OF THE DRAWINGS

FIG. 1 shows a perspective view of the food bar cutter.

FIG. 2 shows a perspective view of the food bar cutter with end blades.

FIG. 3 shows a perspective view of the food bar cutter in a folded orientation.

FIG. 4 shows a perspective view of the food bar cutter positioned over a pan containing a food item.

FIG. 5 shows a perspective view of the food bar cutter with end blades positioned over a pan containing a food item.

FIG. 6 shows a perspective view of the food bar cutter sectioning the food item into a plurality of smaller sections.

FIG. 7 shows a top view of a food item sheet sectioned into a plurality of smaller section within a pan where the margin of the food item has been sectioned from the food item sheet. FIG. 8. FIG. 8 shows another embodiment of the invention.

FIG. 8a shows an enlarged view of the hinge detail.

FIG. 9 shows the cutter of FIG. 8 in a folded configuration.

### DETAILED DESCRIPTION OF THE PREFERRED EMBODIMENT

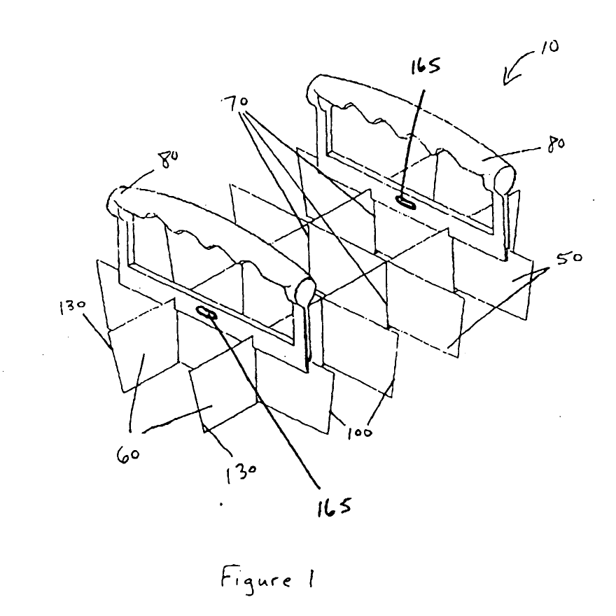

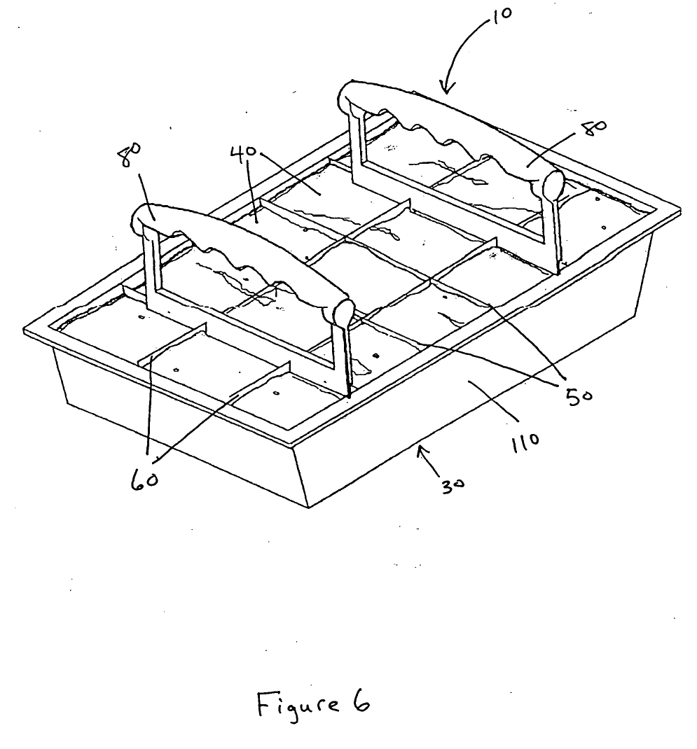

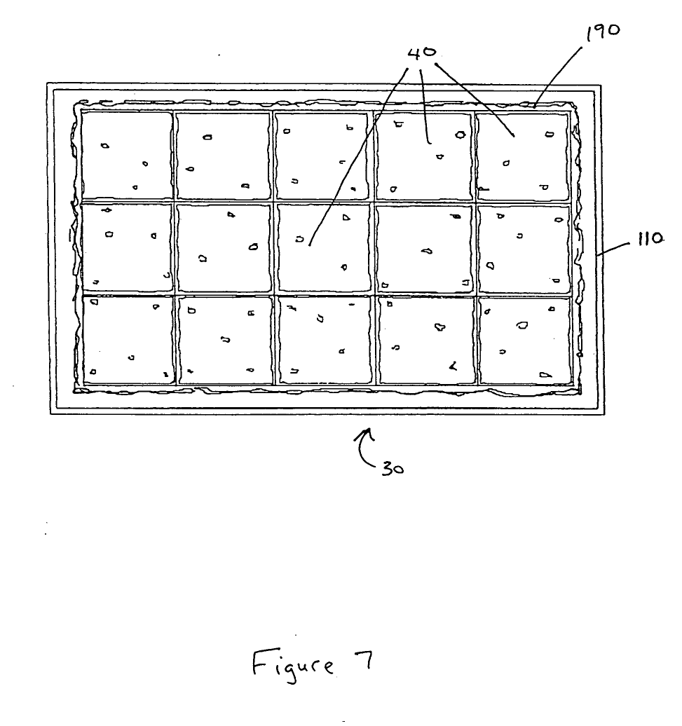

Turning to the drawings, FIG. 1 shows a preferred embodiment of the method-enabling foldable food bar cutter 10 of the claimed invention for sectioning an entire food item 20, such as brownies, cakes, or cookies within a food preparation container or baking pan 30 into a plurality of equally sized smaller sections 40 as illustrated in FIGS. 6 and 7. The food bar cutter 10 generally comprises a plurality of lateral cutting blades 50, a plurality of longitudinal cutting blades 60, a plurality of hinges 70 connecting the lateral and longitudinal blades, and a pair of handles 80.

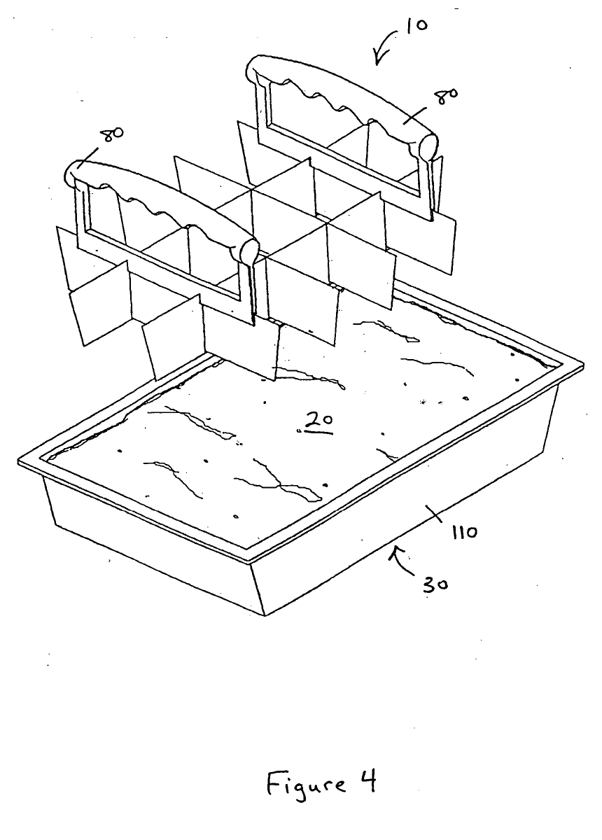

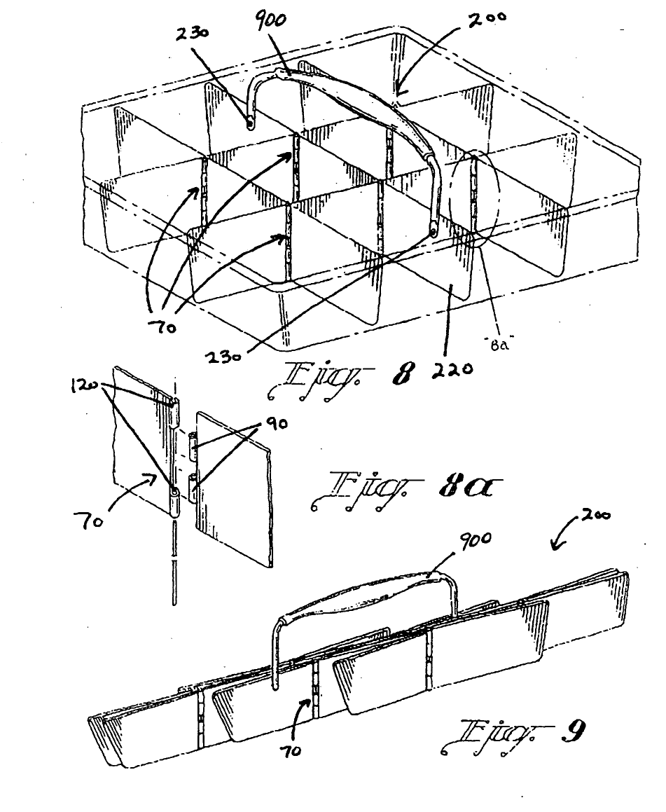

The lateral cutting blades 50 are sized and shaped to laterally section an entire food item 20 width within a baking pan 30 into a plurality of laterally sectioned smaller portions. Each of the lateral cutting blades 50 has two engaging hinge portions 90 spaced at a predetermined distance apart as show in FIGS. 1 and 4. The detail of a preferred embodiment of the hinges 70 having an engaging hinge portion 90 is shown in FIG. 8a. Each of the lateral cutting blades 50 has end portions 100 angled to compensate for the angularity of upright walls 110 of the baking pan 30 when the food bar cutter 10 is pressed into a food item 20 within the baking pan 30 as shown in FIG. 6.

The longitudinal cutting blades 60 are sized and shaped to longitudinally section an entire food item 20 length within a baking pan 30 into a plurality of longitudinally sectioned smaller portions. Each of the longitudinal cutting blades 60 have four retaining hinge portions 120 spaced to hingedly connect to the engaging hinge portions 90 of the lateral cutting blades 50 providing pivotal freedom of movement between the lateral cutting blades 50 and the longitudinal cutting blades 60. The detail of the retaining hinge portion 120 is shown in FIG. 8a. The engaging hinge portions 90 and retaining hinge portions 120 can be switched between the lateral cutting blades 50 and the longitudinal cutting blades 60 and still achieve the desired results of the claimed invention. Each longitudinal cutting blade has end portions 130 angled to compensate for angularity of upright walls 110 of the baking pan 30 when the food bar cutter 10 is pressed into a food item 20 within the baking pan 30 as shown in FIG. 6.

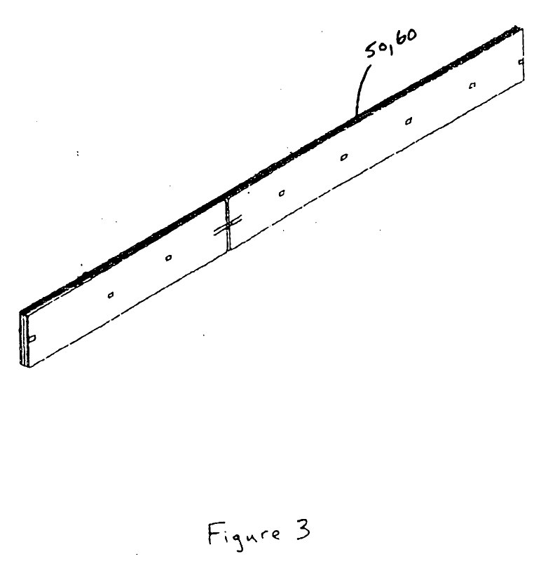

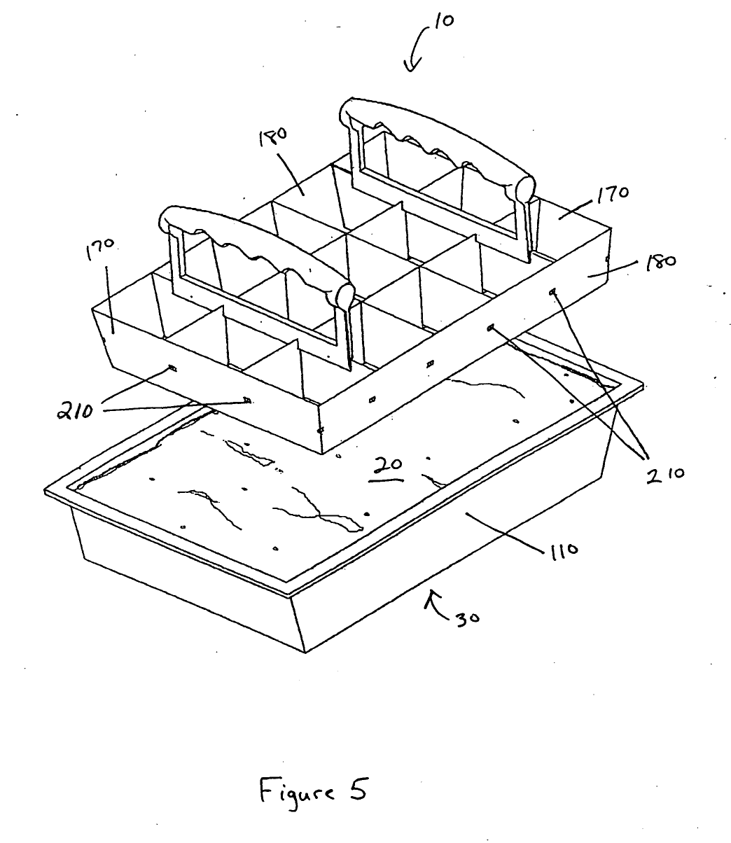

The handles 80 are shaped for applying manual force perpendicular to the lateral cutting blades 50 and longitudinal cutting blades 60 during use. Each handle 80 has a receiving channel 150 for receiving an edge 160 of the lateral blades as shown in FIG. 1. The handles 80 show in FIGS. 1-7 are removable so that the cutter 10 can be folded into a closed position as shown in FIG. 3 where the blades 50, 60 are in a substantially coplanar orientation to reduce space required for storage of the cutter 10.

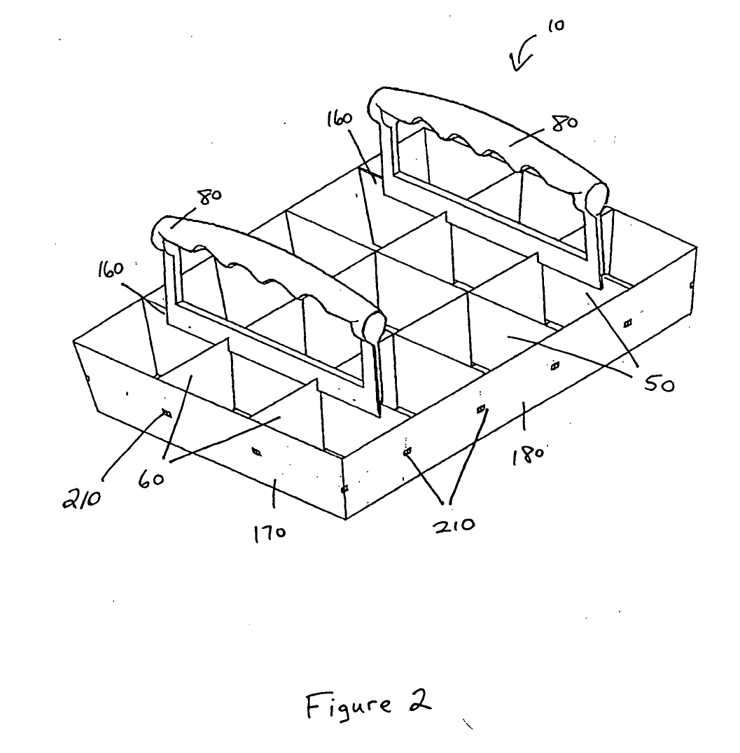

The food bar cutter 10 may also have edge blades 170, 180 as shown in FIG. 2 connected to the ends of the lateral cutting blades 50 and longitudinal cutting blades 60 for cutting off the edge of the food item 20 about the margin 190 of the food item 20 as shown in FIG. 7. Each lateral edge blade 170 has two receiving slots 210 for receiving the end portions 130 of the longitudinal cutting blades 60. Each longitudinal edge blade 180 has four receiving slots 210 for receiving the end portions 100 of the lateral cutting blades 50.

It is contemplated that the food bar cutter 10 may be configured for use in conjunction with a baking pan having dimensions of 9 inches by 12 inches. However, the food bar cutter 10 of the claimed invention can be configured for use with baking pans of other sizes and shapes, such as 9 inches by 9 inches. During use, the lateral cutting blades 50 and the longitudinal cutting blades 60 coact to cut the food item 20 within the pan 30 into a plurality of smaller sections 40 or bars as shown in FIGS. 6 and 7.

FIG. 8 shows another embodiment of the invention where the cutter 200 has a single centrally located handle 900. In this embodiment of the invention, the handle 900 is fastened to one side of the lateral cutting blade 220 to allow the cutter 200 to be folded into a substantially folded or compressed arrangement as shown in FIG. 9.

While the above description contains much specificity, this specificity should not be construed as limitations on the scope of the invention, but rather as an exemplification of the invention. For example, the invention may be said to essentially disclose certain methodology for presenting a sectioned food item within a food preparation container. In this regard, it is contemplated that the method may comprise the steps of changing the arrangement of a plurality of substantially unidirectional cutting blades to an orthogonal cutting blade arrangement as may be the case when each of the longitudinal cutting blades 60 are hingedly connected to the lateral cutting blades 50 providing pivotal freedom of movement between the lateral cutting blades 50 and the longitudinal cutting blades 60. After expanding the blades to an orthogonal arrangement, the same may be moved over a food item within a food preparation container having edges defined by upright food preparation container walls. The orthogonal cutting blade arrangement may then be oriented to fit within the upright food preparation container walls when forced into the food item. The user may then apply force perpendicular to the orthogonal cutting blade arrangement thereby simultaneously and orthogonally sectioning the entire food item into a plurality of smaller food item sections. Thereafter, the orthogonal cutting blade arrangement may be removed from the food item sections for food presentation purposes.

Still further, the methodology may be said to teach a method for presenting a sectioned food preparation or food portion, wherein the method comprises the steps of: varying the angles intermediate adjacent pivotally joined cutting blades to a first select blade orientation; directing the select blade orientation downward into a food preparation; sectioning the food preparation into a plurality of adjacent food sections; directing the select blade orientation upward from the food preparation; and varying the angles intermediate adjacent pivotally joined cutting blades to a second select blade orientation. The first blade orientation may preferably comprise at least one orthogonal blade orientation. The angles intermediate adjacent pivotally joined cutting blades may be uniformly varied to substantially 0 (or 180) degrees. The second blade orientation (for example, the 0 (or 180) degree orientation) may then be stored to conserve storage space. The angles intermediate adjacent pivotally joined cutting blades may be preferably varied to the first select blade orientation from the second select blade orientation. Further, it is noted that at least one select bulk food section may be removed from the series of bulk food sections, the select bulk food section removal forming a food section vacancy.

Accordingly, although the invention has been described by reference to a number of method-enabling embodiments, it is not intended that the novel method-enabling device or inherent methodology be limited thereby, but that certain methodology as enabled thereby is intended to be included as falling within the broad scope and spirit of the foregoing disclosure, the following claims and the appended drawings.

We claim:

1. A method of presenting a sectioned food item within a food preparation container, the method comprising:
changing the arrangement of a plurality of substantially unidirectional cutting blades to an orthogonal cutting blade arrangement;
moving the orthogonal cutting blade arrangement over a food item within a food preparation container having edges defined by upright food preparation container walls;
orienting the orthogonal cutting blade arrangement to fit within the upright food preparation container walls when forced into the food item;
applying force perpendicular to the orthogonal cutting blade arrangement thereby simultaneously and orthogonally sectioning the entire food item into a plurality of smaller food item sections; and
removing the orthogonal cutting blade arrangement from the food item sections.

2. The method of claim 1 comprising the step of moving the orthogonal cutting blade arrangement away from the food item sections after removing the orthogonal cutting blade arrangement from the food item sections.

3. The method of claim 1 comprising the step of returning the orthogonal cutting blade arrangement to an intermediate substantially unidirectional cutting blade arrangement after changing the arrangement of substantially unidirectional cutting blades to the orthogonal cutting blade arrangement.

4. The method of claim 3 comprising the step of storing the substantially unidirectional cutting blade arrangement after returning the orthogonal cutting blade arrangement to the substantially unidirectional cutting blade arrangement.

5. The method of claim 1 comprising the step of displaying the food item sections before removing the orthogonal cutting blade arrangement from the food item sections.

6. The method of claim 1 wherein at least one select food section is removed from the food item sections, the select food section removal forming a food section vacancy.

7. The method of claim 6 comprising the step of displaying the food item sections after the select food section removal.

8. A method of presenting a sectioned food preparation, the method comprising the steps of
varying the angles intermediate adjacent pivotally joined cutting blades to a first select blade orientation;
directing the select blade orientation downward into a food preparation;
sectioning the food preparation into a plurality of adjacent food sections;
directing the select blade orientation upward from the food preparation; and
varying the angles intermediate adjacent pivotally joined cutting blades to a second select blade orientation.

9. The method of claim 8 wherein the first blade orientation comprises at least one orthogonal blade orientation.

10. The method of claim 8 wherein the angles intermediate adjacent pivotally joined cutting blades are uniformly varied to substantially zero degrees.

11. The method of claim 10 comprising the step of storing the second blade orientation.

12. The method of claim 8 wherein the angles intermediate adjacent pivotally joined cutting blades are varied to the first select blade orientation from the second select blade orientation.

13. The method of claim 8 wherein at least one select bulk food section is removed from the series of bulk food sections, the select bulk food section removal forming a food section vacancy.

14. A method of presenting a sectioned food portion, the method comprising the steps of
varying the angles intermediate adjacent pivotally joined cutting blades to a first select blade orientation;
directing the select blade orientation into a bulk food portion;
sectioning the bulk food portion into a series of bulk food sections;
directing the select blade orientation out of the bulk food portion; and
varying the angles intermediate adjacent pivotally joined cutting blades to a second select blade orientation.

15. The method of claim 14 wherein the first blade orientation is varied through at least one orthogonal blade orientation.

16. The method of claim 14 wherein the first blade orientation comprises at least one orthogonal blade orientation.

17. The method of claim 14 wherein the angles intermediate adjacent pivotally joined cutting blades are uniformly varied to substantially zero degrees.

18. The method of claim 17 comprising the step of storing the second blade orientation.

19. The method of claim 14 wherein the angles intermediate adjacent pivotally joined cutting blades are varied to the first select blade orientation from the second select blade orientation.

20. The method of claim 14 wherein at least one select bulk food section is removed from the series of bulk food sections, the select bulk food section removal forming a food section vacancy.
